(19) United States
(12) Patent Application Publication
(10) Pub. No.: US 2025/0270035 A1
(43) Pub. Date: Aug. 28, 2025

(54) DUMPSTER COVER FOR USE WITH A CONSTRUCTION OR TRASH CHUTE

(71) Applicants: Solomon Yakoby, Sunny Isles Beach, FL (US); Philip Faraci, Farmingdale, NY (US)

(72) Inventors: Solomon Yakoby, Sunny Isles Beach, FL (US); Philip Faraci, Farmingdale, NY (US)

(21) Appl. No.: 18/584,997

(22) Filed: Feb. 22, 2024

(51) Int. Cl. B65F 1/16; B65F 1/00; B65F 1/02

(52) U.S. Cl. CPC B65F 1/16; B65F 1/0093; B65F 1/02; B65F 2001/1676

(57) ABSTRACT

A cover for a dumpster having an upper opening for receiving trash or debris includes a substantially impermeable sheet member having a size that is at least as large as the upper opening of the dumpster. The cover also includes an upper surface of the sheet member defining an opening for receiving a chute. The cover includes a first elastic positioned around the outer edge of the sheet member to define a lower opening in the cover for closely fitting around the upper opening of the dumpster and a second elastic positioned around the opening in the upper surface of the sheet member for closely fitting the opening in the upper surface around an exterior of a chute. The cover deters the egress of unwelcome materials and odors from the dumpster during use.

### FIELD

The invention concerns a cover for a receptacle that has an opening for receiving a chute through the top of the cover.

### BACKGROUND

Construction and/or trash chutes are used to drop debris into a dumpster from a height above the dumpster. They are often used in construction rehab projects where noxious materials are deposited down the chute into the dumpster. This can result in dust and obnoxious odors being associated with the construction project. Trash can also cause unwelcome odors. Bleach, lime powder, baking soda and clay cat litter have been used to absorb odors and moisture in dumpsters. However, they do not curb the dust or debris that enters the air around a dumpster after debris has traveled down the chute. A better solution to curb unwelcome materials and odors is needed.

### SUMMARY

A cover for a receptacle, such as a dumpster, is substantially impermeable and has an opening in an upper surface thereof for receiving a chute. The cover has a closure around an opening that surrounds the outer sidewalls of a dumpster. In addition, the cover has an opening that receives the chute therethrough. This opening also has a closure for closing the opening around an exterior of the chute to substantially seal around the exterior surface of the chute to prevent or at least deter odors and dust/debris from exiting the dumpster through the air.

### BRIEF DESCRIPTION OF THE DRAWINGS

FIG. 1 Figure depicts a dumpster cover according to the invention installed on a dumpster.

### DETAILED DESCRIPTION

The present invention is directed toward a dumpster cover for use with a dumpster and a chute, such as a construction or debris chute, or a trash chute. Dumpsters are receptacles that are used for collecting and carrying away debris from construction sites. Dumpsters are also used for collecting trash. Dumpsters can be emptied by carrying them away and dumping them, or by dumping them onsite and refilling them in place.

Chutes are used in multi-story buildings during the construction process to allow construction workers to dump debris into a dumpster during construction projects. Chutes of this nature are typically positioned adjacent an exterior of a building and extend from an opening in the building, such as a window, and extend down into a dumpster. Trash and debris travel through the chute via gravity. Chutes may be round and made of plastic or other slippery materials, or can be formed of wood. Chutes can be rectangular, round, oval-shaped, or other shapes.

Chutes can also be placed inside a building and can travel through multiple floors of a building to a dumpster that is positioned on a lower floor or in the basement of the building. For example, apartment buildings often have trash chutes that permit a resident to dump their trash through an opening in a trash room on each floor. The trash travels down through the building via gravity and empties into a dumpster. Trash rooms can also experience dust and odors because of the trash that is thrown down the chute.

The present invention is designed to solve problems associated with current dumpsters and debris/trash chutes. Dumpster covers are known for keeping material inside a dumpster and for preventing water from entering the dumpster. They can be elasticized around the bottom end and can be impermeable or permeable. Dumpster covers are not known for use with debris or trash chutes. The present invention provides a cover that covers the opening of a dumpster receptacle and has an opening for receiving the chute therethrough to seal the top end of a dumpster and to deter the egress of dust, debris, and odors from the dumpster during use. The cover can also deter or prevent the exit of mold, asbestos, contaminants, and bacteria, among other unwelcome material and odors from the dumpster.

The Figure shows a dumpster cover 10 according to the invention that is positioned around an opening 9 of a dumpster 5. As shown, the dumpster cover 10 is a sheet of material that extends over the opening 9 of the dumpster 5 and has a closure, such as a first elastic 20, positioned around the lower opening 12, that extends around the bottom end 18 of the cover 10. The first elastic 20 may be coupled to the lower opening 12 by stitching or other known means. The dumpster cover 10 is typically larger in size than the opening 9 of the receptacle to provide some room for the chute 7 and to permit the dumpster 5 to be entirely filled.

The cover includes an opening 14 in an upper surface 16 thereof for receiving the chute 7 therethrough. The chute 7, as previously discussed, can be any shape. The opening 14 in the cover preferably is shaped to fit around and substantially seal around any known shaped chute 7. A closure, such as a second elastic 22, can be used to close the upper opening 14 around the chute 7. For example, a round opening 14 can fit around a round, oval, or rectangular chute 7 to substantially seal around the chute 7.

In addition, the first elastic 20 around the bottom opening 12 of the cover 10 substantially seals around the dumpster. The first and second elastics 20, 22 around the openings 12, 14 can be sewn into the material of the cover or otherwise applied as known by those of skill in the art. The first and second elastics 20, 22, may be the same as one another or different from one another. For example, the first elastic 20 could be wider than the second elastic 22, or they could be the same width. In addition to elastic or instead of elastic, a drawstring closure could be used to tighten the opening around the dumpster and the chute. For example, a drawstring could be used in conjunction with elastic to further tighten the elastic around the opening.

The cover 10 is made of an impermeable material, such as a plastic material or a plasticized fabric material. Any known type of material that is impermeable can be utilized. The material can be stretchy or non-stretchy. One type of material that may be used is a heavy duty plastic material having a thickness of 10-12 mils.

The cover 10 is designed to deter the emission of dust and odors from the dumpster 5 into the surrounding air. Thus, the cover 10 is preferably substantially impermeable so that no odors and no dust can exit through the cover or through the openings in the cover. The term “substantially impermeable” is used as a term of estimation to show that a small amount of dust or odors may exit the dumpster in some cases, but the cover deters most odors and dust from exiting the cover.

The cover 10 may be made in different sizes to fit different size dumpsters. For example, a small, medium, and large cover can be provided to fit dumpsters that range in size from 2 yards to 40 yards. A cover 10 of this nature may also be used with trash cans, if desired. The cover 10 can be used inside or outside-anywhere it is desirable to deter the exit of dust/debris and odors from a dumpster 5 that is coupled to a chute.

According to the invention, a cover 10 for a dumpster 5 having an upper opening 9 for receiving trash or debris includes a substantially impermeable material having a size that is at least as large as the upper opening 9 of the dumpster 5, a first closure 20, an opening in the upper surface of the material 14, and a second closure 22. The first closure 20 is positioned around the outer edge 12 of the material to define a lower opening 12 in the cover 10 for closely fitting around an opening 9 of a dumpster 5. The opening 14 in an upper surface of the material defines an opening 14 for receiving a chute 7 therethrough. The second closure 22 is positioned around the opening 14 in the upper surface 16 of the material for closely fitting the opening 14 in the upper surface 16 around an exterior of a chute 7. The cover 10 deters the egress of dust, debris and odors from the dumpster 5 during use.

The first closure 20 may be a first elastic and the second closure 22 may be a second elastic. The material may be a plastic material. The material may be a plasticized fabric material. The first closure 20 may be positioned around the lower opening 12 of the cover 10 and may be attached by sewing or heat sealing to the opening 12. The second closure 22 may be positioned around the opening 14 in the upper surface 16 of the material and may be attached by sewing or heat sealing to the opening 14.

The opening 14 in the upper surface 16 of the material may have a size for receiving the entire diameter of a chute 7 therethrough. The first elastic 20 may be the same as the second elastic 22. The first elastic 20 may be different from the second elastic 22. The material of the cover 10 may be impermeable. The upper opening 14 in the cover 10 may be positioned in a central location of the cover 10. The upper opening 14 in the cover 10 may be positioned off-center on the cover 10.

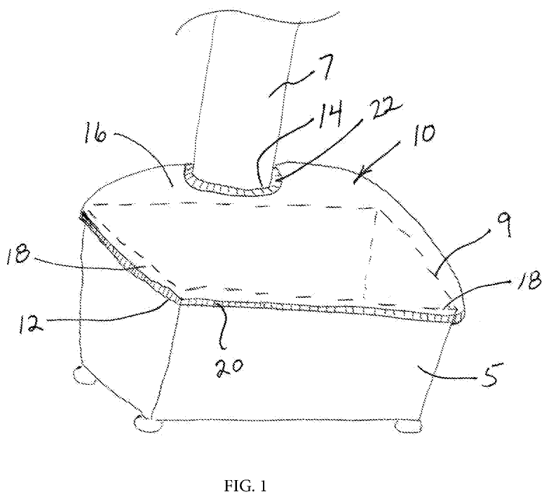

One opening 14 is shown in the cover 10 of FIG. 1. More than one opening 14 may be positioned in the cover 10 for receiving multiple chutes 7. In one embodiment, two openings (not shown) may be provided for receiving two chutes 7, with one opening being positioned on the left side of a dumpster cover 10 for depositing material into the left side of the dumpster 5, and one opening being positioned on the right side of a dumpster cover 10 for depositing material into the right side of the dumpster 5. When two or more openings 14 are provided in the cover 10, they may be closable by a drawstring, Velcro, or other closing mechanism so that only one opening 14 can be used at a time, if desired.

The elastic 20, 22 may be any type of known elastic, as known by those of skill in the art. For example, the elastic 20, 22 can be an elasticized cord or strip. The strip may be one inch wide, two inches wide, or other widths. One type of elastic is a woven elastic. Another type of elastic is a strip of rubber.

The closure may also include a drawstring for permitting the openings 12 and 14 to be tightened further. The drawstring may be used in conjunction with elastic or separately from the elastic. Other closure mechanisms can alternatively be used, such as Velcro, snaps, or other closure mechanisms. These closure mechanisms can be used either in conjunction with the elastic and/or drawstring, or instead of the elastic and/or drawstring.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim. The term “consisting essentially,” if used herein, means the specified materials or steps and those that do not materially affect the basic and novel characteristics of the material or method. The articles “a,” “an,” and “the,” should be interpreted to mean “one or more” unless the context indicates the contrary.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A cover for a dumpster having an upper opening for receiving trash or debris comprising:
a substantially impermeable sheet member having a size that is at least as large as the upper opening of the dumpster;
a first closure positioned around the outer edge of the sheet member to define a lower opening in the cover for closely fitting around an upper opening of a dumpster;
at least one opening in an upper surface of the sheet to define an opening for receiving a chute; and
a second closure positioned around the at least one opening in the upper surface of the sheet for closely fitting the opening in the upper surface around an exterior of a chute,
wherein the cover deters the egress of unwelcome materials and odors from the dumpster during use.

2. The cover of claim 1, wherein the first closure is a first elastic and the second closure is a second elastic.

3. The cover of claim 1, wherein the sheet member is a plastic material.

4. The cover of claim 1, wherein the sheet member is a plasticized fabric material.

5. The cover of claim 1, wherein the first closure positioned around the lower opening of the cover is attached by sewing or heat sealing to the opening.

6. The cover of claim 1, wherein the second closure positioned around the opening in the upper surface of the sheet member is attached by sewing or heat sealing to the opening.

7. The cover of claim 1, wherein the opening in the upper surface of the sheet member has a size for receiving the entire diameter of a chute therethrough.

8. The cover of claim 2, wherein the first elastic is the same as the second elastic.

9. The cover of claim 2, wherein the first elastic is different from the second elastic.

10. The cover of claim 1, wherein the sheet member is impermeable.

11. The cover of claim 1, wherein the upper opening in the cover is positioned in a central location of the cover.

12. The cover of claim 1, wherein the upper opening in the cover is positioned off-center on the cover.

13. The cover of claim 2, wherein the first elastic has a first width and the second elastic has a second width, and the first and second widths are the same.

14. The cover of claim 2, wherein the first elastic has a first width and the second elastic has a second width, and the first and second widths are different.

15. The cover of claim 1, wherein the closure mechanism further comprises a cord for tightening the opening closed.

16. The cover of claim 1, wherein the at least one opening in the sheet comprises multiple openings, with each opening being surrounded by a second closure.
